(19) United States
(12) Patent Application Publication
(10) Pub. No.: US 2007/0122739 A1
(43) Pub. Date: May 31, 2007

(54) Planographic printing plate material and printing process

(75) Inventor: Hidetoshi Ezure, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/603,038

(22) Filed: Nov. 22, 2006

(30) Foreign Application Priority Data
Nov. 29, 2005 (JP) 2005-343499

(51) Int. Cl. G03C 1/00

(52) U.S. Cl. 430/270.1

(57) ABSTRACT

Disclosed is a planographic printing plate material comprising a support and provided thereon, a hydrophilic layer and a thermosensitive image formation layer in that order, wherein the hydrophilic layer contains metal oxide particles (as light-to-heat conversion materials) having a Mohs hardness of from 6.0 to 10.0 and an average particle size of from 0.12 to 0.40 μm and silica particles having an average particle size of from 4.0 to 8.0 μm and a CV of a particle size of from 1 to 10%.

This application is based on Japanese Patent Application No. 2005-343499 filed on Nov. 29, 2005 in Japanese Patent Office, the entire content of which is hereby incorporated by reference.

### FIELD OF THE INVENTION

The present invention relates to a planographic printing plate material and a printing process, and particularly to a planographic printing plate material capable of forming an image according to a computer to plate (CTP) system and a printing process employing the planographic printing plate material.

### BACKGROUND OF THE INVENTION

In recent years, printing employing a CTP system has been conducted in printing industries, accompanied with the digitization of printing data. A printing plate material for CTP, which is inexpensive, can be easily handled, and has a printing ability comparable with that of a PS plate, is required.

A versatile processless printing plate has been sought, which has a direct imaging (DI) property not requiring any development employing a specific developer, can be applied to a printing press with a direct imaging (DI) function, and can be handled in the same manner as in PS plates.

A thermal processless printing plate material is imagewise exposed employing an infrared laser with an emission wavelength of from near-infrared to infrared regions to form an image. The thermal processless printing plate material employing this method is divided into two types; an ablation type printing plate material and an on-press development type printing plate material with a heat melting image formation layer.

Examples of the ablation type printing plate material include those disclosed in for example, Japanese Patent O.P.I. Publication NOS. 8-507727, 6-186750, 6-199064, 7-314934, 10-58636 and 10-244773.

These references disclose a printing plate material comprising a support, and provided thereon, a hydrophilic layer and a lipophilic layer, either of which is an outermost layer. When a printing plate material is imagewise exposed in which the hydrophilic layer is an outermost layer, the hydrophilic layer is removed by ablation to reveal the lipophilic layer, whereby an image is formed. This printing plate material has problem that the exposure device used is contaminated by the ablated matter, and a special suction device is required for removing the scattered material. Therefore, this printing plate material is low in versatility to the exposure device.

A printing plate material has been developed which is capable of forming an image without ablation, and does not require development treatment employing a special developer or wiping-off treatment. There is, for example, a printing plate material for CTP as disclosed in Japanese Publication Nos. 2938397 and 2938397, which comprises a thermosensitive image formation layer containing thermoplastic particles and a water-soluble binder and which is capable of be developed with a dampening solution or printing ink on a printing press.

Generally, the thermosensitive image formation layer described above contains a light-to-heat conversion material (generally colored). When such a thermosensitive image formation layer is subjected to on-press development on a press, the light-to-heat conversion material removed by the on-press development on a press is transferred into dampening solution or printing ink, which may contaminate the printing press.

As a method to prevent such a contamination on-press development, a method is proposed in which a hydrophilic layer containing a light-to-heat conversion material is employed, which makes it possible to remove the light-to-heat conversion material from an image formation layer. This method also provides high sensitivity without contamination of a printing press, by increasing a light-to-heat conversion material content in the hydrophilic layer or by adding a small amount of a light-to-heat conversion material to the image formation layer.

As a method for improving function of a hydrophilic layer, for example, printing performance or image retention property, there are proposed a hydrophilic layer (Japanese Patent O.P.I. Publication No. 2000-225780) containing porous inorganic fillers with a particle size of not more than 1.0 μm, as well as a light-to-heat conversion material and a hydrophilic layer (Japanese Patent O.P.I. Publication No. 2002-370465) containing plural kinds of convexoconcave forming inorganic fillers and an inorganic binder with high porosity as a binder, as well as a light-to-heat conversion material.

However, the techniques described above have problem in that layer strength of the hydrophilic layer or image formation layer is relatively low, and initial ink receptivity or printing durability is insufficient.

As a planographic printing plate material to solve this problem, a planographic printing plate material is known which comprises an image formation layer containing a heat curable resin or a polymerizable monomer (see Japanese Patent O.P.I. Publication Nos. 2005-169902).

However, this planographic printing plate material has still problem in that it is insufficient in scratch resistance, on-press developability, ink receptivity, and printability (such as anti-stain property, water tolerance or stain elimination property, and is likely to produce white spots such as sucker spots or roll spots likely to occur when printing is carried out employing a powdering system or employing printing paper sheets likely to produce powdered paper.

### SUMMARY OF THE INVENTION

Accordingly, an object of the invention is to provide a planographic printing plate material for a CTP system which is excellent in on-press developability, printing performance, printing durability, and scratch resistance.

### DETAILED DESCRIPTION OF THE INVENTION

The above object of the invention can be attained by any one of the following constitutions.

1. A planographic printing plate material comprising a support and provided thereon, a hydrophilic layer and a thermosensitive image formation layer in that order, wherein the hydrophilic layer contains metal oxide particles (as light-to-heat conversion materials) having a Mohs hardness of from 6.0 to 10.0 and an average particle size of from 0.12 to 0.40 μm and silica particles having an average particle size of from 4.0 to 8.0 μm and a CV of a particle size of from 1 to 10%.

2. The planographic printing plate material of item 1 above, wherein the metal oxide particles have a Mohs hardness of from 6.0 to 10.0 and an average particle size of from 0.20 to 0.30 μm, and the silica particles have an average particle size of from 5.0 to 7.0 μm and a CV of a particle size of from 1 to 5%.

3. The planographic printing plate material of item 1 above, wherein the metal oxide of the metal oxide particles is Fe₃O₄, TiO₂ or a compound metal oxide containing Fe and Ti.

4. The planographic printing plate material of item 1 above, wherein the content of the metal oxide particles is from 20 to 60% by weight, and the content of the silica particles is from 3 to 40% by weight.

5. The planographic printing plate material of item 1 above, wherein the hydrophilic layer further contains colloidal silica, alumina sol or titania sol, each having an average particle size of from 3 to 100 nm.

6. The planographic printing plate material of item 1 above, wherein the thermosensitive image formation layer contains heat fusible particles or heat melting particles, each having an average particle size of from 0.01 to 10 μm.

7. The planographic printing plate material of item 6 above, wherein the heat fusible particles and heat melting particles have an average particle size of from 0.1 to 3 μm.

8. The planographic printing plate material of item 6 above, wherein the thermosensitive image formation layer contains the heat melting particles having an average particle size of from 0.01 to 10 μm, and having a softening point of from 40 to 120° C. and a melting point of from 60 to 150° C.

9. The planographic printing plate material of item 1 above, wherein the thermosensitive image formation layer contains an infrared absorbing dye.

10. A printing process comprising the steps of:

(a) imagewise exposing a planographic printing plate material of claim 1;

(b) developing the exposed planographic printing plate material on a plate cylinder of a printing press by supplying to it a dampening solution or both of a dampening solution and printing ink, whereby a printing plate is obtained; and

(c) carrying out printing employing the printing plate.

The invention will be explained in detail below.

The planographic printing plate material of the invention comprises a support and provided thereon, a hydrophilic layer and a thermosensitive image formation layer in that order, wherein the hydrophilic layer contains metal oxide particles (hereinafter also referred to as the metal oxide particles in the invention) having a Mohs hardness of from 6.0 to 10.0 and an average particle size of from 0.12 to 0.40 μm as a light-to-heat conversion materials, and silica particles (hereinafter also referred to as the silica particles in the invention) having an average particle size of from 4.0 to 8.0 μm and a CV of a particle size of from 1 to 10%.

(Definition of Particle Size and Average Particle Size in the Invention)

The particle size referred to in the invention implies an average of the maximum diameter and minimum diameter of a projected particle image of an electron micrograph of particles. The average particle size referred to in the invention implies an average of the particle size of 100 particles arbitrarily selected in an electron micrograph of the particles.

<Hydrophilic Layer>

The hydrophilic layer in the invention contains the metal oxide particles in the invention as a light-to-heat conversion material and the silica particles in the invention. The hydrophilic layer in the invention can provide a planographic printing plate material suitable for a CTP system, which is excellent in ink receptivity, on-press development property, an anti-stain property, water tolerance, printability, printing durability and scratch resistance.

The hydrophilic layer is a layer capable of forming non-image portions, which do not receive printing ink.

(Light-to-Heat Conversion Material)

The hydrophilic layer in the invention contains, as light-to-heat conversion materials, metal oxide particles having a Mohs hardness of from 6.0 to 10.0 and an average particle size of from 0.12 to 0.40 μm.

The light-to-heat conversion material generates heat due to imagewise exposure, whereby an image formation layer at exposed portions forms image portions.

The hydrophilic layer in the invention, containing the metal oxide particles in the invention and the silica particles in the invention, provides a printing plate material which enhances layer strength and is excellent in on-press development property, printability, scratch resistance of non-image portions, and resistance (foreign matter resistance) of image portions to scratches which are likely to occur when printing is carried out employing a powdering system or employing printing paper sheets likely to produce powdered paper.

The metal oxide particles in the invention may be black, electro-conductive, or semi-conducting, and any kinds of metal oxide particles can be used as long as they have a Mohs hardness of from 6.0 to 10.0 and an average particle size of from 0.12 to 0.40 μm as defined above.

The metal oxide particles having a Mohs hardness of from 6.0 to 10.0 include particles of Al₂O₃ (having a Mohs hardness of 9.5), Fe₂O₃ (having a Mohs hardness of 6.0), Cr₂O₃ (having a Mohs hardness of 6.5), CeO₂ (having a Mohs hardness of 6.0), TiO₂ (having a Mohs hardness of 7.0), TiO (having a Mohs hardness of 6.0), SnO₂ (having a Mohs hardness of 6.5), Fe₃O₄ (having a Mohs hardness of 6.5), and compound metal oxides comprising Ti and Fe such as FeO—Fe₂O₃—Tio₂ (having a Mohs hardness of 6.0). Among these, particles of Fe₃O₄, TiO₂ or compound metal oxides containing Ti and Fe are preferably used, which are black (showing high light to heat conversion efficiency) and have high hydrophilicity.

In order to obtain high layer strength, foreign matter resistance and light-to-heat conversion efficiency of the hydrophilic layer, it is necessary that the Mohs hardness of the metal oxide particles in the invention contained in the hydrophilic layer be from 6.0 to 10.0. Further, the average particle size of the metal oxide particles in the invention is from 0.12 to 0.40 μm, in view of layer strength, sensitivity, scratch resistance or printability, and preferably from 0.20 to 0.30 μm.

The content of the metal oxides in the invention in the hydrophilic layer is preferably from 20 to 60% by weight, in view of layer strength, sensitivity, scratch resistance or printability, and more preferably from 30 to 50% by weight.

Well-dispersed metal oxide particles show better light-to-heat conversion efficiency for the content. The metal oxide particles are preferably prepared as a metal oxide particle dispersion before added to a hydrophilic layer coating solution. The metal oxide particle dispersion can be obtained according to a conventional method and a dispersant can be used to obtain the metal oxide particle dispersion.

Metal oxide particles other than the metal oxide particles in the invention can be added to the hydrophilic layer in the invention, as long as they do not lower foreign matter resistance or printability

As the metal oxide particles other than the metal oxide particles in the invention, known metal oxide particles can be used. There are, for example, particles of compound metal oxides containing two or more kinds of metals selected from Al, Ti, Cr, Mn, Fe, Co, Ni, Cu, Zn, Sb, and Ba, except for those having a Mohs hardness of from 6.0 to 10.

These can be synthesized according to the manufacturing methods disclosed in Japanese Patent O.P.I. Publication Nos. 8-27393, 9-25126, 9-237570, 9-241529, and 10-231441. As the compound metal oxides, there are particularly mentioned of Cu—Cr—Mn type compound metal oxides or Cu—Fe—Mn type compound metal oxides. The Cu—Cr—Mn type compound metal oxides are preferably subjected to treatment disclosed in Japanese Patent O.P.I. Publication No. 8-273393, in order to minimize elution of hexavalent chromium ion.

The content in the hydrophilic layer of the metal oxide particles other than the metal oxide particles in the invention is preferably from 0.1 to 10% by weight, and preferably from 1 to 5% by weight, in that foreign matter resistance or printability is not lowered.

(Silica Particles)

It is necessary that the hydrophilic layer in the invention contain silica particles (hereinafter also referred to as the silica particles in the invention) having an average particle size of from 4.0 to 8.0 μm and a CV of from 1 to 10%.

The hydrophilic layer in the invention, containing the metal oxide particles in the invention and the silica particles in the invention, can optimize irregularities of the surface of the hydrophilic layer, improving printability such as water tolerance, scratch resistance at non-image portions, and resistance of image portions to foreign matter occurring when printing is carried out employing a powdering system or employing printing paper sheets likely to produce powdered paper.

The CV in the invention refers to coefficient of variation, and is a measure showing a relative degree of distribution. The less the value CV is, the less the degree of distribution is. Standard deviation is difficult to evaluate, since it is influenced by scale, while the coefficient of variation, even when values having different units are compared with each other, is easy to evaluate, since it removes influence of scale from standard deviation.

A large number of measurements form generally Gaussian distribution, and coefficient of variation of the measurements is computed from average and standard deviation.

In the invention, coefficient of variation CV (%) of a particle size of the silica particles (hereinafter also referred to as CV of the silica particle size) is represented by the following formula:
CV (%) of silica particle size=(Standard deviation of silica particle size)/Average particle size of silica particles)×100

In the invention, average particle size of the silica particles and CV of the silica particle size can be measured through Coulter counter calibrated employing reference particles whose particle size is predetermined.

It is required in the invention that CV of the silica particle size of the silica particles contained in the hydrophilic layer is from 1 to 10%, in view of printability and scratch resistance. The CV of the silica particle size is preferably from 1 to 5%. Silica particles having a CV of a particle size of less than 1% has problem in view of technical points, while silica particles having a CV of a particle size of more than 10% has problem in view of printability and scratch resistance.

It is required in the invention that the average particle size of the silica particles contained in the hydrophilic layer is from 4.0 to 8.0 μm, in view of printability and scratch resistance. The average particle size of the silica particles is preferably from 5.0 to 7.0 μm.

The silica particle content of the hydrophilic layer in the invention is preferably from 3 to 40% by weight, and more preferably from 5 to 25% by weight, in view of layer fastness, scratch resistance and printability.

The content ratio by weight of the metal oxide particles to the silica particles is preferably from 1 to 50, and more preferably from 5 to 30.

The hydrophilic layer in the invention can contain a material for forming a hydrophilic matrix as described below in addition to the light-to-heat conversion material and silica particles described above.

The material for forming the hydrophilic matrix is preferably an additional metal oxide other than the metal oxide described above, and the additional metal oxide is preferably in the form of particles (hereinafter referred to simply as additional metal oxide particles).

Examples of the additional metal oxide particles include colloidal silica, alumina sol, titania sol and another metal oxide sol. The additional metal oxide particles may have any shape such as spherical, needle-like, and feather-like shape. The average particle size of the additional metal oxide particles is preferably from 3 to 100 nm, and more preferably from 5 to 70 nm. Plural kinds of the additional metal oxide particles, each having a different size, may be used in combination. The surface of the particles may be subjected to surface treatment.

The additional metal oxide particles as the material for forming the hydrophilic matrix can be used as a binder, utilizing their layer forming ability. The metal oxide particles are suitably used in a hydrophilic layer since they minimize lowering of hydrophilicity of the layer as compared with an organic compound binder. The content of the additional metal particle oxide as a binder used in the hydrophilic layer is preferably from 0.1 to 95% by weight, and more preferably from 1 to 90% by weight.

Among the above-mentioned, colloidal silica is particularly preferred. The colloidal silica has a high layer forming ability under a drying condition with a relative low temperature, and can provide a good layer strength.

The colloidal silica is preferably necklace-shaped colloidal silica, colloidal silica particles having an average particle size of not more than 20 nm, or an alkaline colloidal silica.

The necklace-shaped colloidal silica is a generic term of an aqueous dispersion system of a spherical silica having a primary particle size of the order of nm. The necklace-shaped colloidal silica means a “pearl necklace-shaped” colloidal silica formed by connecting spherical colloidal silica particles each having a primary particle size of from 10 to 50 μm so as to attain a length of from 50 to 400 nm.

The term of “pearl necklace-shaped” means that the image of connected colloidal silica particles is like to the shape of a pearl necklace. Bonding between the silica particles forming the necklace-shaped colloidal silica is considered to be —Si—O—Si—, which is formed by dehydration of —SiOH groups located on the surface of the silica particles. Concrete examples of the necklace-shaped colloidal silica include Snowtex-PS series produced by Nissan Kagaku Kogyo, Co., Ltd.

It is known that the binding force of the colloidal silica particles is become larger with decrease of the particle size. The average particle size of the colloidal silica particles to be used in the invention is preferably not more than 20 nm, and more preferably 3 to 15 nm. As above-mentioned, the alkaline colloidal silica particles show the effect of inhibiting occurrence of the background contamination. Accordingly, the use of the alkaline colloidal silica particles is particularly preferable.

Examples of the alkaline colloidal silica particles having the average particle size within the foregoing range include Snowtex-20 (average particle size: 10 to 20 nm), Snowtex-30 (average particle size: 10 to 20 nm), Snowtex-40 (average particle size: 10 to 20 nm), Snowtex-N (average particle size: 10 to 20 nm), Snowtex-S (average particle size: 8 to 11 nm) and Snowtex-XS (average particle size: 4 to 6 nm), each produced by Nissan Kagaku Co., Ltd.

The colloidal silica particles having an average particle size of not more than 20 nm, when used together with the necklace-shaped colloidal silica as described above, is particularly preferred, since porosity of the layer is maintained and the layer strength is further increased.

The ratio of the colloidal silica particles having an average particle size of not more than 20 nm to the necklace-shaped colloidal silica is preferably from 95/5 to 5/95, more preferably from 70/30 to 20/80, and most preferably from 60/40 to 30/70.

The hydrophilic layer in the invention can contain porous metal oxide particles having an average particle size less than 1 μm as a porosity-providing agent for forming the hydrophilic matrix. Preferred examples of the porous metal oxide particles include porous silica particles, porous aluminosilicate particles or zeolite particles as described later.

The porous silica particles are ordinarily produced by a wet method or a dry method. By the wet method, the porous silica particles can be obtained by drying and pulverizing a gel prepared by neutralizing an aqueous silicate solution, or pulverizing the precipitate formed by neutralization. By the dry method, the porous silica particles are prepared by combustion of silicon tetrachloride together with hydrogen and oxygen to precipitate silica. The porosity and the particle size of such particles can be controlled by variation of the production conditions. The porous silica particles prepared from the gel by the wet method is particularly preferred. The porous aluminosilicate particles can be prepared by the method described in, for example, JP O.P.I. No. 10-71764.

Thus prepared porous aluminosilicate particles are amorphous complex particles synthesized by hydrolysis of aluminum alkoxide and silicon alkoxide as the major components. The particles can be synthesized so that the ratio of alumina to silica in the particles is within the range of from 1:4 to 4:1. Complex particles composed of three or more components prepared by an addition of another metal alkoxide may also be used in the invention. In such a particle, the porosity and the particle size can be controlled by adjustment of the production conditions.

The porosity of the particles is preferably not less than 1.0 ml/g, more preferably not less than 1.2 ml/g, and most preferably of from 1.8 to 2.5 ml/g, in terms of pore volume.

Examples of the porosity-providing agent include zeolite. Zeolite is a crystalline aluminosilicate, which is a porous material having voids of a regular three dimensional net work structure and having a pore size of 0.3 to 1 nm.

The hydrophilic layer in the invention can contain mineral particles. Examples of the mineral particles include a clay mineral such as kaolinite, halloysite, talc and smectite (for example, montmorillonite, beidellite, hectorite and saponite, vermiculite, mica and chlorite); and layer structural clay mineral particles such as hydrotalcite, and layer structural polysilicates (for example, kanemite, makatite, ilerite, magadiite and kenyle).

Among them, ones having a higher electric charge density of the unit layer are higher in the polarity and in the hydrophilicity. Preferable charge density is not less than 0.25, more preferably not less than 0.6. Examples of the layer structural mineral particles having such a charge density include smectite having a negative charge density of from 0.25 to 0.6 and vermiculite having a negative charge density of from 0.6 to 0.9. Synthesized fluorinated mica is preferable since one having a stable quality, such as the particle size, is available. Among the synthesized fluorinated mica, swellable one is preferable and one freely swellable is more preferable.

With respect to the size of the planar structural mineral particles, the particles have an average particle size of preferably less than 1 μm, and an average aspect ratio of preferably not less than 50, in a state contained in the layer. When the particle size is within the foregoing range, continuity to the parallel direction, which is a trait of the layer structural particle, and softness, are given to the coated layer so that a strong dry layer in which a crack is difficult to be formed can be obtained. The coating solution containing the layer structural clay mineral particles in a large amount can minimize particle sedimentation due to a viscosity increasing effect. The particle size greater than the foregoing may produce a non-uniform coated layer, resulting in poor layer strength.

The content of the layer structural clay mineral particles is preferably from 0.1 to 30% by weight, and more preferably from 1 to 10% by weight based on the total weight of the layer. Particularly, the addition of the swellable synthesized fluorinated mica or smectite is effective if the adding amount is small. The layer structural clay mineral particles may be added in the form of powder to a coating liquid, but it is preferred that gel of the particles which is obtained by being swelled in water, is added to the coating liquid in order to obtain a good dispersity according to an easy coating liquid preparation method which requires no dispersion process comprising dispersion due to media.

An aqueous solution of a silicate is also usable as another additive in the hydrophilic layer in the invention. An alkali metal silicate such as sodium silicate, potassium silicate or lithium silicate is preferable, and the SiO₂/M₂O is preferably selected so that the pH value of the coating liquid after addition of the silicate exceeds 13 in order to prevent dissolution of the inorganic particles.

An inorganic polymer or an inorganic-organic hybrid polymer prepared by a sol-gel method employing a metal alkoxide. Known methods described in S. Sakka “Application of Sol-Gel Method” or in the publications cited in the above publication can be applied to prepare the inorganic polymer or the inorganic-organic hybrid polymer by the sol-gel method.

The hydrophilic layer may contain a water-soluble resin. Examples of the water-soluble resin include polysaccharides, polyethylene oxide, polypropylene oxide, polyvinyl alcohol, polyethylene glycol (PEG), polyvinyl ether, a styrene-butadiene copolymer, a conjugation diene polymer latex of methyl methacrylate-butadiene copolymer, an acryl polymer latex, a vinyl polymer latex, polyacrylamide, and polyvinyl pyrrolidone.

As the polysaccharide, starches, celluloses, polyuronic acid and pullulan can be used. Among them, a cellulose derivative such as a methyl cellulose salt, a carboxymethyl cellulose salt or a hydroxyethyl cellulose salt is preferable, and a sodium or ammonium salt of carboxymethyl cellulose is more preferable.

A water-soluble surfactant may be added to a coating liquid for the hydrophilic layer in the invention for the purpose of improving the coating ability. A silicon atom-containing surfactant, a fluorine atom-containing surfactant or an acetylene glycol type surfactant is preferably used. The silicon atom-containing surfactant is especially preferred in that it minimizes printing contamination. The content of the surfactant is preferably from 0.01 to 3% by weight, and more preferably from 0.03 to 1% by weight based on the total weight of the hydrophilic layer (or the solid content of the coating liquid).

The hydrophilic layer in the invention can contain a phosphate. Since a coating liquid for the hydrophilic layer is preferably alkaline, the phosphate to be added to the hydrophilic layer is preferably sodium phosphate or sodium monohydrogen phosphate. The addition of the phosphate provides improved reproduction of dots at shadow portions. The content of the phosphate is preferably from 0.1 to 5% by weight, and more preferably from 0.5 to 2% by weight in terms of amount excluding hydrated water.

The dry coating amount of the hydrophilic layer is preferably from 0.1 to 20 g/m², and more preferably from 0.5 to 15 g/m², and still more preferably from 1 to 10 g/m².

The plural hydrophilic layers may be provided between the support and the thermosensitive image formation layer. In the invention, the hydrophilic layer refers to a hydrophilic layer farthest from the support. That is, the hydrophilic layer in the invention contacts the thermosensitive image formation layer.

(Thermosensitive Image Formation Layer)

The thermosensitive image formation layer (hereinafter also referred to simply as the image formation layer) is a layer capable of forming an image by imagewise heating, and contains thermoplastic compounds such as heat-melting materials or heat-fusible materials, or materials (hydrophobe precursors which change from hydrophilic property to oleophilic property by heating. Heating is carried out employing heat generated on actinic ray exposure, and preferably heat generated on laser exposure.

The thermosensitive image formation layer in the invention is preferably one capable of being subjected to on-press development, wherein the advantageous effects of the invention are enhanced. In the invention, on-press development implies developing an exposed planographic printing plate material on the plate cylinder of a printing press by supplying a dampening solution or both a dampening solution to the exposed planographic printing plate material, whereby a printing plate is obtained, followed by printing.

It is preferred that the thermosensitive image formation layer in the invention contains the thermoplastic compounds in the form of particles (hereinafter also referred to as thermoplastic particles). That is, the heat-melting materials and heat fusible materials are preferably used as heat-melting particles and heat fusible particles, respectively.

One preferred embodiment of the thermosensitive image formation layer in the invention contains a hydrophobe precursor. As the hydrophobe precursor can be used a polymer whose property is capable of changing from a hydrophilic property (a water dissolving property or a water swelling property) or to a hydrophobic property by heating. Examples of the hydrophobe precursor include a polymer having an aryldiazosulfonate unit as disclosed in for example, Japanese Patent O.P.I. Publication No. 2000-56449.

The heat melting particles are particularly particles having a low melt viscosity, which are particles formed from materials generally classified into wax. The heat melting particles preferably have a softening point of from 40° C. to 120° C. and a melting point of from 60° C. to 150° C., and more preferably a softening point of from 40° C. to 100° C. and a melting point of from 60° C. to 120° C. The melting point less than 60° C. has a problem in storage stability and the melting point exceeding 300° C. lowers ink receptive sensitivity.

Materials used in the heat melting particles include paraffin wax, polyolefin wax, polyethylene wax, microcrystalline wax, and fatty acid ester and fatty acid. The molecular weight thereof is approximately from 800 to 10,000. A polar group such as a hydroxyl group, an ester group, a carboxyl group, an aldehyde group and a peroxide group may be introduced into the wax by oxidation to increase the emulsification ability. Moreover, stearoamide, linolenamide, laurylamide, myristylamide, hardened cattle fatty acid amide, parmitylamide, oleylamide, rice bran oil fatty acid amide, palm oil fatty acid amide, a methylol compound of the above-mentioned amide compounds, methylenebissteastearoamide and ethylenebissteastearoamide may be added to the wax to lower the softening point or to raise the working efficiency. A cumarone-indene resin, a rosin-modified phenol resin, a terpene-modified phenol resin, a xylene resin, a ketone resin, an acryl resin, an ionomer and a copolymer of these resins may also be usable.

Among them, polyethylene wax, microcrystalline wax, fatty acid ester, and fatty acid are preferably contained. A high sensitive image formation can be performed since these materials each have a relative low melting point and a low melt viscosity. These materials each have a lubrication ability. Accordingly, even when a shearing force is applied to the surface layer of the printing plate precursor, the layer damage is minimized, and resistance to stain which may be caused by scratch is further enhanced.

The heat melting particles are preferably dispersible in water. The average particle size thereof is preferably from 0.01 to 10 μm, and more preferably from 0.1 to 3 μm, in view of on-press developability or resolution.

The heat melting particle content of the thermosensitive image formation layer is preferably 1 to 90% by weight, and more preferably 5 to 80% by weight.

The heat fusible particles in the invention include thermoplastic hydrophobic polymer particles. Although there is no specific limitation to the upper limit of the softening point of the thermoplastic hydrophobic polymer, the softening point is preferably lower than the decomposition temperature of the polymer. The weight average molecular weight (Mw) of the thermoplastic hydrophobic polymer is preferably within the range of from 10,000 to 1,000,000.

Examples of the polymer consisting the polymer particles include a diene (co)polymer such as polypropylene, polybutadiene, polyisoprene or an ethylene-butadiene copolymer; a synthetic rubber such as a styrene-butadiene copolymer, a methyl methacrylate-butadiene copolymer or an acrylonitrile-butadiene copolymer; a (meth)acrylate (co)polymer or a (meth)acrylic acid (co)polymer such as polymethyl methacrylate, a methyl methacrylate-(2-ethylhexyl)acrylate copolymer, a methyl methacrylate-methacrylic acid copolymer, or a methyl acrylate-(N-methylolacrylamide); polyacrylonitrile; a vinyl ester (co)polymer such as a polyvinyl acetate, a vinyl acetate-vinyl propionate copolymer and a vinyl acetate-ethylene copolymer, or a vinyl acetate-2-hexylethyl acrylate copolymer; and polyvinyl chloride, polyvinylidene chloride, polystyrene and a copolymer thereof. Among them, the (meth)acrylate polymer, the (meth)acrylic acid (co)polymer, the vinyl ester (co)polymer, the polystyrene and the synthetic rubbers are preferably used.

The polymer particles may be prepared from a polymer synthesized by any known method such as an emulsion polymerization method, a suspension polymerization method, a solution polymerization method and a gas phase polymerization method. The particles of the polymer synthesized by the solution polymerization method or the gas phase polymerization method can be produced by a method in which an organic solution of the polymer is sprayed into an inactive gas and dried, and a method in which the polymer is dissolved in a water-immiscible solvent, then the resulting solution is dispersed in water or an aqueous medium and the solvent is removed by distillation. In both of the methods, a surfactant such as sodium lauryl sulfate, sodium dodecylbenzenesulfate or polyethylene glycol, or a water-soluble resin such as poly(vinyl alcohol) may be optionally used as a dispersing agent or stabilizing agent.

The heat fusible particles are preferably dispersible in water. The average particle size of the heat fusible particles is preferably from 0.01 to 10 μm, and more preferably from 0.1 to 3 μm.

The heat fusible particle content of the image formation layer is preferably from 1 to 90% by weight, and more preferably from 5 to 80% by weight based on the total weight of the layer.

Further, the composition of the heat melting particles or the heat fusible particles may be continuously varied from the interior to the surface of the particles. The particles may be covered with a different material. As a covering method, known methods such as a microcapsule method and a sol-gel method are usable.

The thermosensitive image formation layer in the invention can contain microcapsules encapsulating the heat melting particles or the heat-fusible particles.

Microcapsules used in the printing plate material of the invention include those encapsulating oleophilic materials as disclosed in Japanese Patent O.P.I. Publication Nos. 2002-2135 and 2002-19317.

The average microcapsule size of the microcapsules is preferably from 0.1 to 10 μm, more preferably from 0.3 to 5 μm, and still more preferably from 0.5 to 3 μm.

The thickness of the microcapsule wall is preferably from 1/100 to 1/5 of the average microcapsule size, and more preferably from 1/50 to 1/10 of the average microcapsule size. The microcapsule content of the image formation layer is preferably from 5 to 100% by weight, more preferably from 20 to 95% by weight, and most preferably from 40 to 90% by weight.

As the materials for the microcapsule wall, known materials can be used. As a method of manufacturing the microcapsules, known methods can be used. The materials for the microcapsule wall and the manufacturing method of the microcapsule wall can be applied which are disclosed in for example, Tamotsu Kondo, Masumi Koishi, “New Edition Microcapsule, Its Manufacturing Method, Properties And Application”, published by Sankyo Shuppan Co., Ltd., or disclosed in literatures cited in it.

The thermosensitive image formation layer can contain a water soluble material. The water soluble material improves removability of a thermosensitive image formation layer at unexposed portions when removing it on a press supplying a dampening solution or both a dampening solution and printing ink to the layer.

The water-soluble resin described above, which may be contained in the hydrophilic layer, can be employed as a water-soluble material. The water-soluble resin used in the image formation layer is selected from hydrophilic natural and synthetic polymers. Preferred examples of the water-soluble resin include natural polymers such as gum arabic, water-soluble soybean polysaccharides, cellulose derivatives (such as carboxymethylcellulose, carboxyethylcellulose, methylcellulose and the like) and their modified products, white dextrin, pullulan, and enzymolysis etherified dextrin; and synthetic polymers such as polyvinyl alcohol (preferably with a saponification degree of not less than 70% by mol), polyacrylic acid or its alkaline metal salt or its amine salt, polyacrylic acid copolymer or its alkaline metal salt or its amine salt, polymethacrylic acid or its alkaline metal salt or its amine salt, vinyl alcohol-acrylic acid copolymer or its alkaline metal salt or its amine salt, polyacrylamide or its copolymer, polyhydroxyethyl acrylate, polyvinyl pyrrolidone, its copolymer, polyvinyl methyl ether, vinyl methyl ether-maleic acid anhydride copolymer, poly-2-acrylamide-2-methyl-1-propane sulfonic acid or its alkaline metal salt or its amine salt, and poly-2-acrylamide-2-methyl-1-propane sulfonic acid copolymer or its alkaline metal salt or its amine salt, but the invention is not limited thereto. These may be used singly or in combination.

The water soluble material content of the thermosensitive image formation layer is preferably from 1 to 50% by weight, and more preferably from 2 to 30% by weight.

(Other Materials Optionally Contained in Thermosensitive Image Formation Layer)

The thermosensitive image formation layer can further contain the following materials other than those described above.

The thermosensitive image formation layer preferably contains an infrared absorbing dye.

A combination use of the above-described metal oxide particles and the infrared absorbing dye enhances layer strength of the thermosensitive image formation layer, improving resistance (foreign matter resistance) of the layer to scratches which are likely to occur when printing is carried out employing a powdering system or employing printing paper sheets likely to produce powdered paper.

Examples of the infrared absorbing dye include a general infrared absorbing dye such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound. Exemplarily, the light-to-heat conversion materials include compounds disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These compounds may be used singly or in combination.

The infrared absorbing dye content of the thermosensitive image formation layer is preferably from 0.1% by weight to less than 10% by weight, more preferably from 0.3% by weight to less than 7% by weight, and still more preferably from 0.5% by weight to less than 6% by weight, in preventing ablation.

The coating amount of the image formation layer is preferably from 0.01 to 5 g/m², more preferably from 0.1 to 3 g/m², and still more preferably from 0.2 to 2 g/m².

(Protective Layer)

A protective layer can be provided on the thermosensitive image formation layer.

As materials used in the protective layer, the water-soluble resins described above can be preferably used.

As the protective layer, the overcoat layer disclosed in Japanese Patent O.P.I. Publication Nos. 2002-19318 and 2002-86948 can be preferably used.

The coating amount of the protective layer is from 0.01 to 10 g/m², preferably from 0.1 to 3 g/m², and more preferably from 0.2 to 2 g/m².

(Support)

As a support of the printing plate material, those conventionally used as supports for printing plates can be used. Examples of such a support include a metal plate, a plastic film, a paper sheet treated with polyolefin, and composite sheets such as laminates thereof. The thickness of the support is not specifically limited as long as a printing plate having the support can be mounted on a printing press, and is advantageously from 50 to 500 μm in easily handling.

Examples of the metal plate include iron, stainless steel, and aluminum. Aluminum or aluminum alloy (hereinafter also referred to as aluminum) is especially preferable in its gravity and stiffness. Aluminum is ordinarily used after degreased with an alkali, an acid or a solvent to remove oil on the surface, which has been used when rolled and wound around a spool. Degreasing is preferably carried out employing an aqueous alkali solution.

The support is preferably subjected to adhesion enhancing treatment or subbing layer coating in order to enhance adhesion of the support to a layer to be coated. There is, for example, a method in which the support is immersed in, or coated with, a solution containing silicate or a coupling agent, and then dried. Anodization treatment is considered to be one kind of the adhesion enhancing treatment and can be employed as such. Further, a combination of the anodization treatment with the immersion or coating as above can be employed. An aluminum plate to have been surface roughened according to a conventional method can be also employed.

Examples of resin for the plastic film include polyethylene terephthalate, polyethylene naphthalate (PEN), polyimide, polyamide, polycarbonate, polysulfone, polyphenylene oxide, and cellulose ester.

Among these, polyester such as PET or PEN is preferred, and PET is especially preferred, in view of handling with ease.

PET is a polycondensate of terephthalic acid and ethylene glycol, and PEN is a polycondensate of naphthalene dicarboxylic acid and ethylene glycol. These polyesters are obtained by condensation polymerization of the respective monomers and optionally one or more kinds of a third component in the presence of appropriate catalysts.

As the third component, there is a compound having a divalent ester-forming functional group capable of forming an ester.

As the dicarboxylic acid, there is, for example, isophthalic acid, phthalic acid, 2,6-naphthalene dicarboxylic acid, 2,7-naphthalene dicarboxylic acid, diphenylsulfone dicarboxylic acid, diphenylether dicarboxylic acid, diphenylthioether dicarboxylic acid, diphenylketone dicarboxylic acid, diphenylindane dicarboxylic acid, and as a diol, there is, for example, propylene glycol, tetramethylene glycol, cyclohexanedimethanol, 2,2-bis(4-hydroxyphenyl)propane, 2,2-bis(4-hydroxyethoxyphenyl)propane, bis(4-hydroxyphenyl)-sulfone, bisphenolfluorene dihydroxyethyl ether, diethylene glycol, hydroquinone, cyclohexane diol. The third component may be a polycarboxylic acid or a polyol, but the content of the polycarboxylic acid or polyol is preferably from 0.001 to 5% by weight based on the weight of polyester.

The intrinsic viscosity of the resin for the plastic film is preferably from 0.5 to 0.8. Polyesters having different viscosity may be used as a mixture of two or more kinds thereof.

A synthetic method of the polyester in the invention is not specifically limited, and the polyester can be synthesized according to a conventional polycondensation method. As the synthetic method, there is a direct esterification method in which a dicarboxylic acid is directly reacted with a diol or an ester exchange method in which dialkyl ester as a dicarboxylic acid component is reacted with a diol while heating under reduced pressure where produced diol is removed.

In the synthetic method above, an ester exchange catalyst, a polymerization catalyst or a heat-resistant stabilizer can be used. Examples of the heat-resistant stabilizer include Phosphoric acid, phosphorous acid, PO(OH) (CH₃)₃, PO(OH) (OC₆H₅)₃, and P(OC₆H₅)₃. During synthesis of the polyesters, an anti-stain agent, a crystal nucleus agent, a slipping agent, an anti-blocking agent, a UV absorber, a viscosity adjusting agent, a transparentizing agent, an anti-static agent, a pH adjusting agent, a dye or pigment may be added.

(Particles)

Particles having a size of from 0.01 to 10 μm are preferably incorporated in an amount of from 1 to 1000 ppm into the support, in improving handling property.

Herein, the particles may be organic or inorganic material. Examples of the inorganic material include silica described in Swiss Patent 330158, glass powder described in French Patent 296995, and carbonate salts of alkaline earth metals, cadmium or zinc described in British Patent 1173181. Examples of the organic material include starch described in U.S. Pat. No. 2,322,037, starch derivatives described such as in Belgian Patent 625451 and British Patent 981198, polyvinyl alcohol described in JP-B 44-3643, polystyrene or polymethacrylate described in Swiss Patent 330158, polyacrylonitrile described in U.S. Pat. No. 3,079,257 and polycarbonate described in U.S. Pat. No. 3,022,169. The shape of the particles may be in a regular form or irregular form.

The support in the invention has a coefficient of elasticity of preferably from 300 to 800 kg/mm², and more preferably from 400 to 600 kg/mm², in view of improving handling property of the printing plate material of the invention.

The coefficient of elasticity herein referred to is a slope of the straight line portion in the stress-strain diagram showing the relationship between strain and stress, which is obtained employing a tension test meter according to JIS C2318. This slope is called Young's modulus, which is defined in the invention as coefficient of elasticity.

It is preferred that the support in the invention has an average thickness of from 100 to 500 μm, and a thickness distribution of not more than 5%, in that when the planographic printing plate material is mounted on a press, the handling property is improved. It is especially preferred that the support in the invention has an average thickness of from 120 to 300 μm, and a thickness distribution of not more than 2%.

The thickness herein referred to means a value (%) obtained by dividing the difference between the maximum thickness and the minimum thickness by the average thickness and then multiplying the difference by 100.

The thickness distribution of the support is determined according to the following: lines are formed at an interval of 10 cm in both the transverse and longitudinal directions on a 60 cm square polyester film sheet to form 36 small squares. The thickness of the 36 small squares is measured, and the average thickness, maximum thickness and minimum thickness are obtained therefrom.

The support in the invention is preferably a plastic sheet, but may be a composite support in which a plate of a metal (for example, iron, stainless steel or aluminum) or a polyethylene-laminated paper sheet is laminated onto the plastic sheet. The composite support may be one in which the lamination is carried out before any layer is coated on the support, one in which the lamination is carried out after any layer has been coated on the support, or one in which the lamination is carried out immediately before mounted on a printing press.

In the invention, a subbing layer is preferably provided between the support and the hydrophilic layer.

The subbing layer is preferably comprised of two layers, a lower subbing layer closer to the support and an upper subbing layer closer to the hydrophilic layer. The lower subbing layer preferably contains a material having strong adhesion to the support, and the upper subbing layer preferably contains a material having strong adhesion to both the lower subbing layer and the hydrophilic layer.

Examples of the material for the lower subbing layer include vinyl polymers, polyesters, and styrene-diolefin copolymers. Among these, vinyl polymers, polyesters and a mixture thereof are preferred. The vinyl polymers and polyesters are preferably modified.

The material for the upper subbing layer is preferably a water soluble polymer in providing improved adhesion to the hydrophilic layer. Examples of the material for the upper subbing layer include gelatin, polyvinyl alcohol, modified polyvinyl alcohol, water soluble acryl resins, and water soluble polyesters. The upper subbing layer preferably contains the water soluble polymers and the material used in the lower subbing layer, in order to provide strong adhesion to both the lower subbing layer and the hydrophilic layer.

When a PET sheet is used as a support, a subbing layer containing polyvinyl alcohol, acryl resin or polyesters is preferably provided on the PET sheet. When an aluminum sheet is used as a support, a subbing layer containing carboxymethylcellulose, polyvinyl alcohol, acryl resin or polyesters is preferably provided on the aluminum sheet.

The subbing layer as described above enhances adhesion between the support and the hydrophilic layer, improving foreign matter resistance or on-press development of the planographic printing plate material.

The inorganic material particles as described below can be employed for the subbing layer. Examples of the inorganic material include silica, alumina, barium sulfate, calcium carbonate, titania, tin oxide, indium oxide, and talc. These particle shapes are not particularly limited, and any shape such as needle-like, spherical, plate-like, or fracture-like shape can be used. The particle size is preferably 0.1-15 μm, more preferably 0.2-10 μm, and still more preferable 0.3-7 μm. The coating amount of the particles in the subbing layer on one side of the support is preferably 0.1-50 mg/m², more preferably 0.2-30 mg/m², and still more preferably 0.3-20 mg/m².

The thickness of the subbing layer is preferably 0.05-0.50 μm in view of transparency and uneven coating (interference unevenness), and more preferably 0.10-0.30 μm.

It is preferred that the subbing layer is formed by coating a subbing layer coating liquid on either one surface or both surfaces of polyester film particularly before completing crystalline orientation during manufacturing of the film, or by coating a subbing layer coating liquid on either one surface or both surfaces of polyester film in on line or off line after manufacturing of the film.

As a coating method of the subbing layer, any conventional coating methods may be employed. It is preferable to apply, singly or in combination, the coating methods such as a kiss coating method, a reverse coating method, a die coating method, a reverse kiss coating method, an offset gravure coating method, a Meyer bar coating method, a roller brush method, a spray coating method, an air-knife coating method, a dip-coating method and a curtain coating method.

It is preferable to provide an antistatic layer on the subbing layer. The antistatic layer is comprised of an antistatic agent and a binder.

A metal oxide is preferably employed as an antistatic agent. Examples of such a metal oxide include ZnO, TiO₂, SnO₂, Al₂O₃, In₂O₃, SiO₂, MgO, BaO, MoO₂, V₂O₅, and compound oxides. Specifically, from the viewpoint of miscibility with a binder, electrical conductivity and transparency, SnO₂ (being tin oxide) is preferred. As a metal oxide containing a different atom, there is, for example, SnO₂ added with Sb, Nb or a halogen atom. The added amount of the different atom is in the range of preferably 0.01-25 mol %, and more preferably 0.1-15 mol %.

(Exposure)

In the invention, an image is formed on the planographic printing plate material of the invention by imagewise heating. The imagewise heating is preferably carried out employing a laser. A thermal laser is especially preferred as the laser employed.

The imagewise exposure is preferably scanning exposure, which is carried out employing a laser, which can emit light having a wavelength of infrared and/or near-infrared regions, that is, a wavelength of from 700 to 1500 nm. As the laser, a gas laser can be used, but a semi-conductor laser, which emits light having a near-infrared region wavelength, is preferably used.

A device suitable for the scanning exposure in the invention may be any device capable of forming an image on the printing plate material according to image signals from a computer employing a semi-conductor laser.

Generally, the following scanning exposure processes are mentioned.

(1) A process in which a plate precursor provided on a fixed horizontal plate is scanning exposed in two dimensions, employing one or several laser beams.

(2) A process in which the surface of a plate precursor provided along the inner peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

(3) A process in which the surface of a plate precursor provided along the outer peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

In the invention, the process (3) above is preferable, and especially preferable when a printing plate material mounted on a plate cylinder of a printing press is scanning exposed.

(Printing)

In the invention, a conventional printing process, which employs a dampening solution and printing ink, can be applied. It is preferred in the invention that the dampening solution contains no isopropanol or contains isopropanol in an amount of not more than 0.5% by weight based on the weight of water used.

Employing the thus printing plate material after image recording, printing is carried out without a special development process. That is, the printing plate material after imagewise exposed with a laser is developed on a plate cylinder of a printing press by supplying a dampening water or both of dampening water and printing ink, whereby a printing plate is obtained, and then printing is carried out employing the printing plate.

After the printing plate material is imagewise exposed and mounted on a plate cylinder of a printing press, or after the printing plate material is mounted on the cylinder and then imagewise heated to obtain a printing plate material, a dampening water supply roller and/or an ink supply roller are brought into contact with the surface of the resulting printing plate material while rotating the plate cylinder to remove non-image portions of the image formation layer of the printing plate material.

Removal of the non-image portions, so-called, on-press development, will be explained below.

Removal (on-press development) of the non-image portions (unexposed portions) of the image formation layer of a printing plate material mounted on the plate cylinder, can be carried out by bringing a dampening roller and an inking roller into contact with the image formation layer while rotating the plate cylinder. On-press development can be carried out, for example by various sequences as described below or another appropriate sequence. The supplied amount of dampening solution may be adjusted to be greater or smaller than the amount ordinarily supplied in printing, and the adjustment may be carried out stepwise or continuously.

Sequence (1) A dampening roller is brought into contact with the image formation layer of a printing plate material on the plate cylinder during one to several tens of rotations of the plate cylinder, and then an inking roller brought into contact with the image formation layer during the next one to tens of rotations of the plate cylinder. Thereafter, printing is carried out.

Sequence (2) An inking roller is brought into contact with the image formation layer of a printing plate material on the plate cylinder during one to several tens of rotations of the plate cylinder, and then a dampening roller brought into contact with the image formation layer during the next one to tens of rotations of the plate cylinder. Thereafter, printing is carried out.

Sequence (3) An inking roller and a dampening roller are brought into contact with the image formation layer of a printing plate material on the plate cylinder during one to several tens of rotations of the plate cylinder. Thereafter, printing starts.

### EXAMPLES

Next, the present invention will be explained employing examples, but the present invention is not limited thereto. In the examples, “parts” represents “parts by weight”, and “%” represents % by weight, unless otherwise specified.

(Preparation of Support 1)

(PET Resin)

Added to 100 parts by weight of dimethyl terephthalate, and 65 parts by weight of ethylene glycol, was 0.05 parts by weight of magnesium acetate anhydrate as an ester exchange catalyst, and an ester exchange reaction was conducted under commonly known practice. To the obtained product, added were 0.05 parts by weight of antimony trioxide and 0.03 parts by weight of trimethyl phosphate ester. Subsequently, subjected to a gradual temperature rise and pressure reduction, polymerization was conducted at 280° C. and 66.6 Pa, to obtain polyethylene terephthalate (PET) resin having an intrinsic viscosity of 0.70. Employing the PET resin as obtained above, biaxially oriented PET film was prepared as described below.

(Biaxially Oriented PET Film)

The PET resin was palletized and subjected to vacuum drying at 150° C. for 8 hours. After that, the resin was melt-extruded at 285° C. from a T die to form a layer, and the layer was electrostatically impressed on a 30° C. cooling drum while electrostatically impressed, and cooled to solidification, whereby unoriented film was obtained. This unoriented film was stretched at a factor of 3.3 in the longitudinal direction, employing a roll type longitudinal stretching machine. Subsequently, the resulting uniaxially oriented film, using a tenter type transverse stretching machine, was stretched at 90° C. by 50% of the total transverse stretch magnification in the first stretching zone, and then stretched at 100° C. in the second stretching zone so that the total transverse stretch magnification was 3.3. Further, the resulting film was preheated at 70° C. for two seconds, heat-set at 150° C. for five seconds in the first setting zone and at 220° C. for 15 seconds in the second setting zone, and relaxed at 160° C. by 5% in the transverse (width) direction. After passed through the tenter, the film was cooled to room temperature in 60 seconds, released from the clips, slit and wound around a core to obtain a 175 μm thick biaxially oriented PET film. The Tg of this biaxially oriented PET film was 79° C., and the thickness distribution of the film was 2%.

The biaxially oriented PET film as obtained above was subjected to corona discharge treatment at 8 W/m²·min. Subsequently, a subbing layer coating solution a-1 was coated on the surface of the film on the side of a hydrophilic layer to be formed, and dried at 123° C. to form subbing layer A-1 with a dry thickness of 0.8 μm on the surface of the film on the hydrophilic layer side.

The resulting film was subjected to corona discharge treatment at 8 W/m²·min on the subbing layer A-1, was coated with subbing layer coating solution a-2 on the subbing layer A-1, and dried at 123° C. to form subbing layer A-2 with a dry thickness of 0.1 μm on the subbing layer A-1. Thus, support 1 (with a subbing layer on one surface of the film) was obtained.

(Subbing layer coating solution a-1)

| | | |
|---|---|---|
| Latex of styrene/glycidyl methacrylate/butyl acrylate | 250 | g |
| (60/39/1) copolymer (Tg = 75° C.) with a solid content | | |
| of 30% | | |
| Latex of styrene/glycidyl methacrylate/butyl acrylate | 25 | g |
| (20/40/40) copolymer (Tg = 20° C.) with a solid content | | |
| of 30% | | |
| Anionic surfactant S-1 (2% by weight) | 30 | g |
| Water was added to make 1 kg. | | |
| (Subbing layer coating solution a-2) | | |
| Modified water-soluble polyester L-4 solution | 31 | g |
| (23% by weight) | | |
| Aqueous solution (5% by weight) of EXCEVAL (polyvinyl | 58 | g |
| alcohol/ethylene copolymer) RS-2117, produced | | |
| by Kuraray Co., Ltd. | | |
| Anionic surfactant S-1 (2% by weight) | 6 | g |
| Hardener H-1 (0.5% by weight) | 100 | g |
| Spherical silica matting agent SEAHOSTAR KE-P50 | 10 | g |
| (produced by Nippon Shokubai Co., Ltd.) 2% dispersion | | |
| Distilled water was added to make 1000 ml. | | |

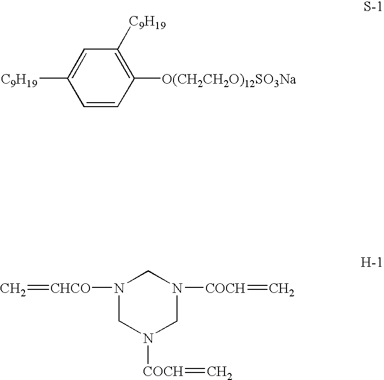 (Preparation of Modified Water-Soluble Polyester L-4 Solution)

A mixture consisting of 35.4 parts by weight of dimethyl terephthalate, 33.63 parts by weight of dimethyl isophthalate, 17.92 parts by weight of sodium salt of dimethyl 5-sulfoisophthalate, 62 parts by weight of ethylene glycol, 0.065 parts by weight of calcium acetate monohydrate, and 0.022 parts by weight of manganese acetate tetrahydrate was subjected to ester exchange reaction at 170 to 220° C. under a flow of nitrogen while distilling out methanol. Thereafter, 0.04 parts by weight of trimethyl phosphate, 0.04 parts by weight of antimony trioxide, and 6.8 parts by weight of 4-cyclohexanedicarboxylic acid were added. The resulting mixture underwent esterification at a reaction temperature of 220 to 235° C. while distilling out a nearly theoretical amount of water. Thereafter, the reaction system was heated over a period of one hour under reduced pressure, and subjected to polycondensation under a maximum pressure of 133 Pa for 1 hour, while heated to a final temperature of 280° C. Thus, water-soluble polyester was prepared. The intrinsic viscosity of the resulting polyester was 0.33, and the weight average molecular weight of the resulting polyester was 80,000 to 100,000.

Subsequently, 850 ml of pure water was placed in a 2-liter three-necked flask fitted with stirring blades, a refluxing cooling pipe, and a thermometer, and 150 g of the water-soluble polyester was gradually added while rotating the stirring blades. The resulting mixture was stirred at room temperature for 30 minutes, heated to 98° C. over a period of 1.5 hours, and maintained at that resulting temperature for 3 hours, whereby dissolution was performed. Thereafter, the mixture was cooled to room temperature over a period of one hour, and allowed to stand overnight, whereby a 15% by weight water-soluble polyester solution A1 was prepared.

One thousand nine hundred milliliters of the foregoing 15% by weight water-soluble polyester solution A1 were placed in a 3-liter four-necked flask fitted with stirring blades, a reflux cooling pipe, a thermometer and a dripping funnel, and heated to 80° C., while rotating the stirring blades. Into this added was 6.52 ml of a 24% aqueous ammonium peroxide solution, and a monomer mixture (consisting of 28.5 g of glycidyl methacrylate, 21.4 g of ethyl acrylate and 21.4 g of methyl methacrylate) was dropwise added over a period of 30 minutes, and the mixture was reacted for additional 3 hours. Thereafter, the reaction mixture was cooled to not more than 30° C., and filtrated. Thus, a modified water-soluble polyester solution B1 having a solid content of 18% by weight was obtained. Herein, the modified water-soluble polyester was polyester modified with the acryl monomers, and the acryl-modified rate in the modified water-soluble polyester was 20% by weight.

Modified water-soluble polyester L-4 solution was prepared in the same manner as above, except that the acryl-modified rate was 5% by weight and the solid content was 23% by weight.

(Preparation of Support 2, Aluminum Support)

A 0.24 mm thick aluminum plate (AA1050) was degreased in a sodium hydroxide solution to be an aluminum dissolution amount of 2 g/m². The resulting plate was sufficiently washed with pure water, immersed at 70° C. for 30 seconds in a 1 weight % sodium dihydrogenphosphate solution, then sufficiently washed with pure water, and dried. Thus, support 2 was obtained.

Lower Hydrophilic Layer Coating Liquid)

Materials shown in Table 1 were mixed in a homogenizer while stirring, and filtered to obtain a lower hydrophilic layer coating solution.

TABLE 1
Lower hydrophilic layer coating solution

| | Solid | |
|---|---|---|
| | content | Amount |
| Materials | (%) | (g) |
| Porous metal oxide: Silton JC-40 | 100 | 13.0 |
| Layer structural clay mineral | 5 | 26.0 |
| Montmorillonite: Mineral Colloid MO gel | | |
| (porous aluminosilicate particles having | | |
| an average particle diameter of 4 μm, | | |
| produced by Mizusawa Kagaku Co., Ltd.) | | |
| prepared by vigorously stirring | | |
| Montmorillonite Mineral Colloid MO in | | |
| water with a homogenizer to give a solid | | |
| content of 5% | | |
| Cu—Fe—Mn type metal oxide black pigment: | 40 | 58.5 |
| TM-3550 black aqueous dispersion (prepared | | |
| by dispersing TM-3550 black powder having | | |
| a particle diameter of about 0.1 μm | | |
| produced by Dainichi Seika Kogyo Co., Ltd. | | |
| in water to give a solid content of 40% | | |
| (including 0.2% by weight of dispersant) | | |
| Carboxymethylcellulose CMC (Reagent | 4 | 17.5 |
| produced by Kanto Kagaku Co., Ltd.) 4% | | |
| aqueous solution | | |
| Sodium phosphate•dodecahydrate (Reagent | 10 | 4.0 |
| produced by Kanto Kagaku Co., Ltd.) 10% | | |
| aqueous solution | | |
| Colloidal silica: Snowtex-XS (produced by | 20 | 363 |
| Nissan Kagaku Co., Ltd., solid content of | | |
| 20%) | | |
| Colloidal silica: Snowtex-ZL (produced by | 20 | 11.5 |
| Nissan Kagaku Co., Ltd., solid content of | | |
| 20%) | | |
| Silica particles as shown in Table 4 | 100 | 8.20 |
| Silicon surfactant: FZ2161 (produced by | 20 | 8.20 |
| Nippon Unicar Co., Ltd., solid content of | | |
| 20%) | | |
| Pure water | — | 498.3 |
| Total weight (g) | — | 1000 |

(Upper Hydrophilic Layer Coating Liquid)

Materials shown in Table 2 were mixed in a homogenizer while stirring, and filtered to obtain an upper hydrophilic layer coating solution.

TABLE 2
Upper hydrophilic layer coating solution

| | Solid | |
|---|---|---|
| | content | Amount |
| Materials | (%) | (g) |
| Metal oxide particles* as shown in Table 4 | 36 | 561 |
| (solid content of 36%) | | |
| Carboxymethylcellulose CMC (Reagent | | |
| produced by Kanto Kagaku Co., Ltd.) 4% | | |
| aqueous solution (used only in sample 14 | 4 | 1.0 |
| in Table 4) | | |
| Sodium phosphate•dodecahydrate* (Reagent | | |
| produced by Kanto Kagaku Co., Ltd.) 10% | 10 | 1.0 |
| aqueous solution | | |
| Colloidal silica: Snowtex-XS (produced by | | |
| Nissan Kagaku Co., Ltd., solid content of | 30 | 91.0 |
| 30%) | | |
| Colloidal silica: Snowtex-PSM (produced by | | |
| Nissan Kagaku Co., Ltd., solid content of | 20 | 220 |
| 20% by weight) | | |
| Silica particles as shown in Table 4 (used | 100 | 8.0 |
| in support 2 but not in support 1) | | |
| Silicon surfactant FZ2161 (produced by | | |
| Nippon Unicar Co., Ltd.) 20% solution | 20 | 8.0 |
| Porous metal oxide particles: Silton AMT- | | |
| 08* (0.8 μm in average particle diameter, | 100 | 24.0 |
| produced by Mizusawa Kagaku Co., Ltd.) | | |
| Colloidal silica: MP4540M (produced by | | |
| Nissan Kagaku Co., Ltd., solid content of | 40 | 86.0 |
| 40%) | | |
| Total weight (g) | — | 1000 |

*The metal oxide particles as shown in Table 4 were mixed with AMT-08 and sodium phosphate•dodecahydrate solution, and dispersed in a DyanoMill.

(Coating of Lower and Upper Hydrophilic Layer Coating Solutions)

The lower hydrophilic layer coating solution was coated on the subbing layer surface of support 1 employing a wire bar, and allowed to pass through a 100° C. drying zone with a length of 15 m at a transportation speed of 15 m/minute to obtain a lower hydrophilic layer with a dry coating amount of 3.0 g/m².

Subsequently, the upper hydrophilic layer coating solution was coated on the lower hydrophilic layer employing a wire bar, and allowed to pass through a 100° C. drying zone with a length of 30 m at a transportation speed of 15 m/minute to obtain an upper hydrophilic layer with a dry coating amount of 1.80 g/m².

Next, only the upper hydrophilic layer coating solution was coated on the support 2 employing a wire bar, and allowed to pass through a 100° C. drying zone with a length of 30 m at a transportation speed of 15 m/minute to obtain an upper hydrophilic layer with a dry coating amount of 1.80 g/m².

The above-obtained coated samples were subjected to aging treatment at 60° C. for 2 days.

(Preparation of Thermosensitive Image Formation Layer Coating Solution)

Thermosensitive image formation layer coating solutions W, X, Y and Z having a composition shown in Table 3 were prepared.

(Preparation of Planographic Printing Plate Material Samples)

The thermosensitive image formation layer coating solution obtained above was coated onto the above-mentioned upper hydrophilic layer employing a wire bar, then allowed to pass through a 70° C. drying zone with a length of 30 m at a transportation speed of 15 m/minute to form a thermosensitive image formation layer with a dry coating amount of 0.55 g/m², and subjected to aging treatment at 50° C. for 2 days. Thus, planographic printing plate material samples were prepared.

TABLE 3

| | Image formation layer coating solution | | | | | | | |
|---|---|---|---|---|---|---|---|---|
| Materials | W | | X | | Y | | Z | |
| Carnauba wax emulsion: A118 (having an average | 110 | g | 110 | g | 110 | g | 110 | g |
| particle diameter of 0.3 μm, a melting point of 80° | | | | | | | | |
| C., and a solid content of 40%, produced by GIFU | | | | | | | | |
| SHELLAC CO., LTD.) | | | | | | | | |
| Microcrystalline wax emulsion: A206 (having an | 40.0 | g | 40.0 | g | 40.0 | g | — | |
| average particle diameter of 0.5 μm and a solid | | | | | | | | |
| content of 40%, produced by GIFU SHELLAC CO., LTD.) | | | | | | | | |
| Polyethylene wax emulsion: A514 (having an average | 30.0 | g | 30.0 | g | 30.0 | g | — | |
| particle diameter of 0.6 μm, a melting point of 113° | | | | | | | | |
| C., a molecular weight of 1,000 and a solid content | | | | | | | | |
| of 40%, produced by GTFU SHELLAC CO., LTD.) | | | | | | | | |
| Stearic amide wax: Himicron L-271 (having a solid | 63.0 | g | 63.0 | g | 40.0 | g | — | |
| content of 25%, produced by CHUKYO YUSHI CO., LTD.) | | | | | | | | |
| Wax core/shell latex MCDISPA (comprising paraffin wax | — | | — | | — | | 110 | g |
| (mp. 75° C.) as cores and styrene-acryl resin as | | | | | | | | |
| shells, the styrene-acryl resin containing an acrylic | | | | | | | | |
| acid monomer unit, produced by Nippon Seiro Co., | | | | | | | | |
| Ltd.) | | | | | | | | |
| *2.0% or 5% IPA solution of Infrared absorbing dye | — | | 105 | g | 105 | g | 105 | g |
| ADS830AT (produced by American Dye Source Co., Ltd.) | | | | | | | | |
| Penon JE-66 (having a solid content of 10%, produced | 21.0 | g | 21.0 | g | 21.0 | g | 21.0 | g |
| by Nippon Starch Chemical Co., Ltd.) | | | | | | | | |
| Sodium polyacrylate aqueous solution obtained by | 263 | g | 263 | g | 263 | g | 263 | g |
| diluting DL522 (having a molecular weight of 170,000 | | | | | | | | |
| and a solid content of 30%, produced by Nippon | | | | | | | | |
| Shokubai Co., Ltd.) with water by a factor of 10 | | | | | | | | |
| IPA (Isopropyl alcohol) | 15.0 | g | 15.0 | g | 15.0 | g | 15.0 | g |
| Pure water | 458 | g | 353 | g | 313 | g | 313 | g |
| Total weight (g) | 1000 | g | 1000 | g | 1000 | g | 1000 | g |

*A 2.0% IPA solution of Infrared absorbing dye ADS830AT was used for PET supports, and a 5.0% IPA solution of Infrared absorbing dye ADS830AT for aluminum supports.

Each of the planographic printing plate material samples obtained above was cut into a width of 660 mm. Then, samples having the support 1 (employing PET film) were wound 30 m around a paper core having an outer diameter of 76 mm to form a planographic printing plate material sample in the roll form. Samples having the support 2 (employing aluminum plate) were in the sheet form.

(Evaluation)

Exposure

Each of the resulting printing plate material samples was cut so as to suit an exposure device, wound around an exposure drum of the exposure device and imagewise exposed. Exposure was carried out employing laser having a wavelength of 830 nm and a laser beam spot diameter of 18 μm at a resolution of 2,400 dpi with exposure energy of 240 mJ/cm² to form an image with a screen number of 175 lines (The term, “dpi” shows the number of dots per 2.54 cm.). Thus, the exposed printing plate material sample with an image was obtained.

Printing Method

DAIYA 1-F produced by Mitsubishi Jukogyo Co., Ltd. was used as a printing press. Printing was carried out employing dampening water, 2% by weight of Astromark 3 (produced by Nikken Kagaku Kenkyusho), and ink, Toyo Hyunity Magenta (produced by Toyo Ink Manufacturing Co.) to conduct the printing evaluation as described later. Printing was carried out employing coated paper sheets, except when printing durability was evaluated. At the time of printing tables, powder (Trade name: Nikkalyco M, produced by Nikka Ltd.) was sprayed at a printing press powder scale of 10.

(on-Press Development Property)

Printing was carried out according to the printing conditions described above, and the number of printed copies consumed from when printing started until when a print having an excellent S/N ratio was obtained was determined as a measure of on-press development property. The print having an excellent S/N ratio refers to one in which no background contamination was observed at non-image portions, showing that an image formation layer at non-image portions was completely removed on the press, and image density at image portions was in an appropriate range. The less the number is, the better the on-press development property. The number not less than 40 is practically problematic.

(Printing Durability)

Printing was carried out to print on the other surface of woodfree paper sheets with a printed image on one surface thereof, and terminated when either lack of 3% small dots in an image or lowered density at solid image portions was confirmed. The number of printed copies printed until the printing termination was determined as a measure of printing durability.

(Scratch Resistance)

Scratch resistance at non-image portions and image portions was evaluated according to the following method.

Scratch Resistance at Non-Image Portions

The image formation layer surface of the samples before exposure was rubbed by using the nail portion of an index finger, and the actual damage level at the non-image portions of 20^{th} printed paper sheet was evaluated according to the following criteria.

A: No ink contamination was observed

B: Slight ink contamination was observed.

C: Some ink contamination was observed.

D: Ink contamination with the same density as at 50% dot image portions was observed.

E: Ink contamination with the same density as at solid image portions was observed.

Scratch Resistance (Foreign Matter Resistance) at Image Portions

On-press development was carried out according to the printing conditions described above, except for employing a printing plate material sample exposed to form a dot image with 50% dot area. To the surface of the resulting printing plate sample were adhered finishing lines cut to a 5 mm length and having a thickness of from 50 to 250 μm, the thickness changed at an interval of 20 μm. Printing was carried out employing the printing plate samples with the finishing lines to obtain 1000 copies.

After that, printing suspended and the surface of the blanket and the printing plate sample was cleaned with a cleaner to remove adhered finishing lines, and printing restarted to obtain additional 100 copies. The size of white spots in the image portions in the 100^{th} copy was measured and evaluated as a measure of foreign matter resistance at image portions. The white spots in the image portions were portions where finishing lines had been present before cleaning. The larger the size of the white spots, the better the foreign matter resistance, which means that even large foreign matter is difficult to produce white spots.

(Background Contamination Resistance)

The color difference ΔE between the non-image portions of the print after printing 10000 copies and an original printing paper sheet was measured employing a color checker SPM-100 produced by Gretag Macbeth Company, and evaluated as a measure of background contamination resistance, which was one of printability evaluation. A practical problem is caused when the color difference (ΔE) is 0.5 or more.

(Water Tolerance)

Printing was carried out according to the printing conditions described above, while reducing rotational frequency (represented in terms of %) of the water fountain roller of the printing press, and maximum rotational frequency, at which contaminations at non-image portions were observed, was determined, and evaluated as a measure of water tolerance, which was another one of printability evaluation. The less the maximum rotational frequency is, the better the water tolerance and printability.

The results are shown in Table 4. As is apparent from Table 4, inventive planographic printing plate material samples provide excellent on-press development property, printing durability, printability, and scratch resistance.

TABLE 4

| | | | | | Silica | | | | | |
|---|---|---|---|---|---|---|---|---|---|---|
| | | Metal oxide | | | particles in | | | CMC in | Thermo- | |
| | | particles in upper | | | upper or | | | upper | sensi- | |
| Sam- | Sup- | hydrophilic layer | | | lower hydro- | | | hydro- | tive image | |
| ple | port | | | Mohs | philic layers | | | philic | formation | Re- |
| No. | No. | Kinds | (1) | hardness | Kinds | (1) | CV | layer | layer | marks |
| 1 | 1 | A | 0.05 | 3 | a | 6.5 | 12 | — | X | Comp. |
| 2 | 1 | A | 0.05 | 3 | mx | 5.5 | 13 | — | X | Comp. |
| 3 | 1 | A | 0.05 | 3 | b | 6.0 | 2 | — | X | Comp. |
| 4 | 1 | D | 0.10 | 5.5 | a | 6.5 | 12 | — | X | Comp. |
| 5 | 1 | B | 0.20 | 7 | a | 6.5 | 12 | — | X | Comp. |
| 6 | 1 | A | 0.05 | 3 | a | 6.5 | 12 | — | X′ | Comp. |
| 7 | 1 | B | 0.2 | 7 | b | 6 | 2 | — | X | Inv. |
| 8 | 1 | B | 0.2 | 7 | b | 6 | 2 | — | X′ | Inv. |
| 9 | 1 | B | 0.2 | 7 | b | 6 | 2 | — | X′ | Inv. |
| 10 | 1 | C | 0.2 | 6 | b | 6 | 2 | — | X | Inv. |
| 11 | 1 | MX | 0.2 | 3, 6, 7 | b | 6 | 2 | — | X′ | Inv. |
| 12 | 1 | MX | 0.2 | 3, 6, 7 | b | 6 | 2 | — | Y | Inv. |
| 13 | 2 | MX | 0.2 | 3, 6, 7 | b | 6 | 2 | — | Y | Inv. |
| 14 | 2 | MX | 0.2 | 3, 6, 7 | b | 6 | 2 | Present | Y | Inv. |
| 15 | 2 | MX | 0.2 | 3, 6, 7 | b | 6 | 2 | — | Z | Inv. |
| 16 | 1 | B | 0.2 | 7 | c | 4 | 2 | — | Y | Inv. |
| 17 | 1 | B | 0.2 | 7 | d | 8 | 2.5 | — | Y | Inv. |
| 101 | 1 | B | 0.2 | 7 | e | 4 | 30 | — | Y | Inv. |
| 102 | 1 | B | 0.2 | 7 | f | 5.8 | 6 | — | Y | Inv. |
| 103 | 1 | B | 0.2 | 7 | g | 8 | 10 | — | Y | Inv. |
| 104 | 1 | B | 0.2 | 7 | h | 2 | 2 | — | Y | Comp. |
| 105 | 1 | B | 0.2 | 7 | i | 10 | 2 | — | Y | Comp. |
| 106 | 1 | B | 0.2 | 7 | j | 2 | 16 | — | Y | Comp. |
| 107 | 1 | B | 0.2 | 7 | k | 10 | 34 | — | Y | Comp. |
| 18 | 1 | D | 0.12 | 6 | b | 6 | 2 | — | Y | Inv. |
| 19 | 1 | E | 0.4 | 9.5 | b | 6 | 2 | — | Y | Inv. |
| 20 | 1 | F | 0.13 | 10 | b | 6 | 2 | — | Y | Inv. |
| 21 | 1 | G | 0.4 | 6 | b | 6 | 2 | — | Y | Inv. |
| 201 | 1 | H | 0.05 | 6 | b | 6 | 2 | — | Y | Comp. |
| 202 | 1 | I | 0.05 | 9.5 | b | 6 | 2 | — | Y | Comp. |
| 206 | 1 | M | 0.5 | 9.5 | b | 6 | 2 | — | Y | Comp. |
| 207 | 1 | N | 0.45 | 7 | b | 6 | 2 | — | Y | Comp. |

| | On-press | Scratch | | | Back- | Scratch | |
|---|---|---|---|---|---|---|---|
| | development | resistance | Printing | Water | ground | resis- | |
| Sam- | property | at image | dura- | tol- | contam- | tance at | |
| ple | (Number of | portions | bility | erance | ination | non-image | Re- |
| No. | sheets) | (μm) | (x1000) | (%) | (ΔE) | portions | marks |
| 1 | 24 | 50 | 2 | 30 | 0.7 | E | Comp. |
| 2 | 28 | 70 | 3 | 38 | 1.1 | D | Comp. |
| 3 | 18 | 50 | 2 | 35 | 0.9 | D | Comp. |
| 4 | 15 | 90 | 4 | 30 | 0.7 | E | Comp. |
| 5 | 20 | 70 | 2 | 35 | 0.8 | E | Comp. |
| 6 | 32 | 70 | 3 | 38 | 0.9 | E | Comp. |
| 7 | 12 | 150 | 8 | 25 | 0.2 | A | Inv. |
| 8 | 18 | 150 | 9 | 28 | 0.4 | C | Inv. |
| 9 | 15 | 190 | 12 | 22 | 0.3 | B | Inv. |
| 10 | 10 | 150 | 10 | 20 | 0.1 | A | Inv. |
| 11 | 8 | 170 | 13 | 22 | 0.2 | A | Inv. |
| 12 | 8 | 170 | 12 | 20 | 0.1 | A | Inv. |
| 13 | 10 | 190 | 14 | 20 | 0.1 | B | Inv. |
| 14 | 13 | 210 | 16 | 23 | 0.2 | B | Inv. |
| 15 | 8 | 210 | 18 | 28 | 0.3 | A | Inv. |
| 16 | 6 | 160 | 9 | 18 | 0.1 | B | Inv. |
| 17 | 10 | 190 | 12 | 24 | 0.2 | A | Inv. |
| 101 | 8 | 180 | 10 | 20 | 0.1 | B | Inv. |
| 102 | 12 | 190 | 11 | 22 | 0.2 | A | Inv. |
| 103 | 8 | 210 | 13 | 24 | 0.3 | A | Inv. |
| 104 | 22 | 80 | 3 | 20 | 0.2 | E | Comp. |
| 105 | 16 | 110 | 4 | 36 | 1.2 | B | Comp. |
| 106 | 32 | 60 | 2 | 24 | 0.4 | E | Comp. |
| 107 | 12 | 120 | 4 | 40 | 1.6 | B | Comp. |
| 18 | 8 | 150 | 12 | 20 | 0.1 | A | Inv. |
| 19 | 8 | 230 | 16 | 26 | 0.3 | B | Inv. |
| 20 | 8 | 150 | 9 | 20 | 0.1 | A | Inv. |
| 21 | 10 | 170 | 12 | 22 | 0.2 | A | Inv. |
| 201 | 15 | 80 | 2 | 30 | 0.4 | C | Comp. |
| 202 | 16 | 90 | 2 | 32 | 0.5 | C | Comp. |
| 206 | 23 | 130 | 3 | 35 | 0.6 | D | Comp. |
| 207 | 20 | 110 | 3 | 32 | 0.6 | D | Comp. |

Comp.: Comparative; Inv.: Inventive
(1) : Average particle size (μm)

In Table 4, materials used in the hydrophilic layer and thermosensitive image formation layer of the planographic printing plate material samples are shown below.

(Metal Oxide Particles)

A: Fe—Cu—Mn compound oxide TM-3550 (aqueous dispersion having a solid content of 40% by weight produced by Titan Kogyo Co., Ltd.) having an average particle size of 0.05 μm and a Mohs hardness of 3

B: Iron oxide BL-200 (produced by Titan Kogyo Co., Ltd.) having an average particle size of 0.2 μm and a Mohs hardness of 7

C: Fe—Ti compound oxide ETB-300 (produced by Titan Kogyo Co., Ltd.) having an average particle size of 0.2 μm and a Mohs hardness of 6

D: Titan Black 13M (produced by Mitsubishi Material Co., Ltd.) having an average particle size of 0.1 μm and a Mohs hardness of 5.5

MX: Mixture of A, B and C (2:36:4 by weight ratio)

E: α-Alumina (Al₂O₃) having an average particle size of 0.40 μm and a Mohs hardness of 9.5

F: α-Alumina (Al₂O₃) having an average particle size of 0.12 μm and a Mohs hardness of 9.5

G: Fe—Ti compound oxide ETB-100 (produced by Titan Kogyo Co., Ltd.) having an average particle size of 0.35 μm and a Mohs hardness of 6

H: Crystalline tin oxide (SnO₂) having an average particle size of 0.05 μm and a Mohs hardness of 6

I: α-Alumina (Al₂O₃) having an average particle size of 0.05 μm and a Mohs hardness of 9.5

M: α-Alumina (Al₂O₃) having an average particle size of 0.50 μm and a Mohs hardness of 9.5

N: Iron oxide ABL-203 (produced by Titan Kogyo Co., Ltd.) having an average particle size of 0.45 μm and a Mohs hardness of 7

(Silica Particles)

a: Optobeads 6500S (produced by Nichireki Kagaku Co., Ltd.) having an average particle size of 6.5 μm and a CV of 2%

b: Highprecica FQ (produced by Ube Nitto Kasei Co., Ltd.) having an average particle size of 6.0 μm and a CV of 2%

mx: Mixture of Highprecica FQ having an average particle size of 5.0 μm, Highprecica FQ having an average particle size of 5.5 μm and Highprecica FQ having an average particle size of 6.0 μm (1:1:1 by weight ratio), the CV thereof being 13%

c: Highprecica FQ (produced by Ube Nitto Kasei Co., Ltd.) having an average particle size of 4.0 μm and a CV of 2%

d: Highprecica SS (produced by Ube Nitto Kasei Co., Ltd.) having an average particle size of 8.0 μm and a CV of 2.5%

e: JC-40 (produced by Mizusawa Kagaku Kogyo Co., Ltd.) having an average particle size of 4.0 μm and a CV of 30%

f: Mixture of Highprecica FQ having an average particle size of 5.5 μm and Highprecica FQ having an average particle size of 6.0 μm (1:1 by weight ratio), each having a CV of 6%

g: Mixture of Highprecica FQ having an average particle size of 7.7 μm, Highprecica FQ having an average particle size of 8.0 μm and Highprecica FQ having an average particle size of 8.3 μm (1:1:1 by weight ratio), each having a CV of 10%

h: Highprecica FQ (produced by Ube Nitto Kasei Co., Ltd.) having an average particle size of 2 μm and a CV of 2%

i: Highprecica FQ (produced by Ube Nitto Kasei Co., Ltd.) having an average particle size of 10 μm and a CV of 2%

j: JC-20 (produced by Mizusawa Kagaku Kogyo Co., Ltd.) having an average particle size of 2 μm and a CV of 16%

k: Sansfair H-101 (produced by Dokai Kagaku Co., Ltd.) having an average particle size of 10.0 μm and a CV of 34%

What is claimed is:

1. A planographic printing plate material comprising a support and provided thereon, a hydrophilic layer and a thermosensitive image formation layer in that order, wherein the hydrophilic layer contains metal oxide particles (as light-to-heat conversion materials) having a Mohs hardness of from 6.0 to 10.0 and an average particle size of from 0.12 to 0.40 μm and silica particles having an average particle size of from 4.0 to 8.0 μm and a CV of a particle size of from 1 to 10%.

2. The planographic printing plate material of claim 1, wherein the metal oxide particles have a Mohs hardness of from 6.0 to 10.0 and an average particle size of from 0.20 to 0.30 μm, and the silica particles have an average particle size of from 5.0 to 7.0 μm and a CV of a particle size of from 1 to 5%.

3. The planographic printing plate material of claim 1, wherein the metal oxide of the metal oxide particles is Fe₃O₄, TiO₂ or a compound metal oxide containing Fe and Ti.

4. The planographic printing plate material of claim 1, wherein the content of the metal oxide particles is from 20 to 60% by weight, and the content of the silica particles is from 3 to 40% by weight.

5. The planographic printing plate material of claim 1, wherein the hydrophilic layer further contains colloidal silica, alumina sol or titania sol, each having an average particle size of from 3 to 100 nm.

6. The planographic printing plate material of claim 1, wherein the thermosensitive image formation layer contains heat fusible particles or heat melting particles, each having an average particle size of from 0.01 to 10 μm.

7. The planographic printing plate material of claim 6, wherein the heat fusible particles and heat melting particles have an average particle size of from 0.1 to 3 μm.

8. The planographic printing plate material of claim 6, wherein the thermosensitive image formation layer contains the heat melting particles having an average particle size of from 0.01 to 10 μm, and having a softening point of from 40 to 120° C. and a melting point of from 60 to 150° C.

9. The planographic printing plate material of claim 1, wherein the thermosensitive image formation layer contains an infrared absorbing dye.

10. A printing process comprising the steps of:
(a) imagewise exposing a planographic printing plate material of claim 1;
(b) developing the exposed planographic printing plate material on a plate cylinder of a printing press by supplying to it a dampening solution or both of a dampening solution and printing ink, whereby a printing plate is obtained; and
(c) carrying out printing employing the printing plate.
